(19) United States
(12) Patent Application Publication
(10) Pub. No.: US 2010/0056072 A1
(43) Pub. Date: Mar. 4, 2010

(54) IN-CABLE FM TUNER-TRANSMITTER CONNECTOR

(75) Inventors: Dan Hua, San Jose, CA (US); Yasuhiro Yamamoto, Los Angeles, CA (US)

Correspondence Address: LARIVIERE, GRUBMAN & PAYNE, LLP, 19 UPPER RAGSDALE DRIVE, SUITE 200, MONTEREY, CA, 93940, US

(73) Assignee: Monster Cable Products, Inc., Brisbane, CA (US)

(21) Appl. No.: 12/201,418

(22) Filed: Aug. 29, 2008

(51) Int. Cl. H04B 1/38

(52) U.S. Cl. 455/77

(57) ABSTRACT

An apparatus consisting of a connecting cable with a built-in FM tuner and transmitter that connects a portable entertainment device with an external entertainment system over a number of preset frequencies, and which the user can quickly operate without needing to look at the apparatus in order to select a different FM frequency for playback operation if the need arises.

### TECHNICAL FIELD

The present invention relates to cables and tuner-transmitters for connecting portable personal electronic devices with external entertainment systems. More particularly, the present invention relates to connecting cable systems for receiving input from portable personal electronic devices and conveying them to an external entertainment system. Even more particularly, the present invention relates to connecting cables and FM tuner-transmitters for receiving electronic signals from portable personal electronic devices, transforming the signals, and conveying them to an external entertainment system.

### BACKGROUND ART

It is common in the present society for individuals to carry a portable personal electronic device (PPED) which provides to the user an entertaining output, either audio or video, from a memory capability within the PPED. The PPED has evolved from a portable radio which receives a signal from an external source and transforms it into an audible signal presented through either a speaker or ear phones. The typical PPED now contains a memory device which the user can load with music, video, data, etc. for playback at a later time, thus freeing it from the limitation of available local broadcast sources.

When a user is traveling in a vehicle, or otherwise near an external entertainment system (EES) which he desires to use as the playback outlet, it is necessary to connect the PPED with the EES, either wirelessly or through a wire or cable. This is frequently accomplished by connecting a cable between the PPED and the EES. Typically the playback occurs over an unused FM frequency to the EES which receives the signal from the PPED and presents it to the user. Given the extensive use of the FM frequency bands, the user must have a variety of frequencies from which to choose in order to avoid conflict with an active FM station.

When using the PPED, the user may often have occasion to change the settings for the output connection. In a moving vehicle for example, an FM frequency that is not used in one location may be in use in a new location in which the vehicle is operating. This requires the PPED user to change some connection setting to utilize another, unused, frequency. If the PPED user is the vehicle operator, it is imperative that attention to safely driving the vehicle take precedence over changing the PPED settings. Thus, what is needed is a PPED-EES connecting apparatus that the operator can conveniently manipulate without detracting from the safe operation of the vehicle.

### DISCLOSURE OF THE INVENTION

Accordingly, the present invention is an apparatus consisting of a connecting cable with a housing containing a built-in FM tuner and transmitter that connects a PPED, such as an iPod®, iPhone®, portable DVD player, and the like, with an EES, such as a home entertainment center, a car radio or a DVD player. The apparatus can be operated without needing to look at the apparatus in order to quickly select a different FM frequency for playback operation if the need arises.

The present invention uniquely combines an electronic cable in two segments with appropriate electronic connectors for connecting the chosen PPED with an EES. Each cable segment is configured with an electronic jack-type connector on one end and a rotatable electronic connector on the other end. The rotatable connectors connect physically and electronically with the housing which contains suitable FM circuitry for receiving the signals from the PPED and transforming them in a manner suitable for connecting with an EES. The connection with the EES is preferably wireless but can be either hard wired or wireless.

The housing includes a dial selector for preset FM frequency taps selected from typically un-used FM frequencies, or other suitable frequencies as appropriate. Each tap is represented by a detent-type position which physically holds the selector at the selected detent, providing the user with a fast, tactile feedback which the user can interpret as a positive connection, avoiding the need for the user to visually inspect the selector to determine which frequency is selected. The present invention incorporates a 360 degree dial selector that can be operated in either a clockwise or counterclockwise direction, without the need to reverse direction at some internal stop. The housing may further contain a display portion to visually confirm to the user the selected frequency in use.

### BRIEF DESCRIPTION OF THE DRAWING

For a better understanding of the present invention, reference is made to the below referenced accompanying Drawing. Reference numbers refer to the same or equivalent parts of the present invention throughout the several figures of the Drawing.

FIG. 1 is a pictorial cut-away view of the housing of the present invention.

FIG. 2 is a line cut-away drawing of the housing of the present invention.

### BEST MODES FOR CARRYING OUT THE INVENTION

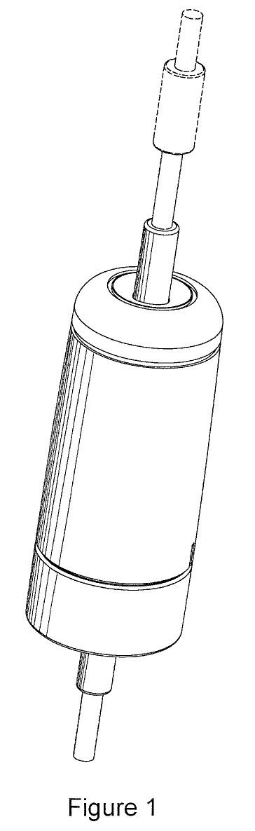

Referring now to FIG. 1, a pictorial cut-away view of the housing 10 of the exemplary preferred embodiment of present invention is shown. First cable 11 goes to an EES and typically is terminated at one end with an electronic jack connector (not shown) suitable for an EES. Rotatable connector 13 is physically connected with housing 10 and electrically connects cable 11 to the electronic circuitry within housing 10. Alternatively, connector 13 may be detachably connected with housing 10 if a variety of cables 11 is desired. Similarly, rotatable connector 14 is physically connected with housing 10 and electrically connects the electronic circuitry within housing 10 to second cable 12 for connection with the PPED. Alternatively, connector 14 may be detachably connected with housing 10 if a variety of cables 12 is desired. Rotatable connectors 13 and 14 allow cables 11 and 12 respectively, to rotate in use without twisting the overall cable.

The external portion of housing 10 has two sections, a fixed shell 15 and a cylindrical rotatable frequency selector dial 16. Dial 16 is freely rotatable and selects one of the preset frequencies. If desired, the housing may also contain a transparent display section 17. Display section 17 is typically a back lighted transparent panel which identifies the frequency selected by the user. Alternatively, the display section 17 could display any datum or data consisting of lights, symbols or numbers, employing for example light emitting diodes or printed transparent screens. While a cylindrical housing 10 is shown, it is to be understood that any shape housing could be used without departing from the intent and teaching of this disclosure.

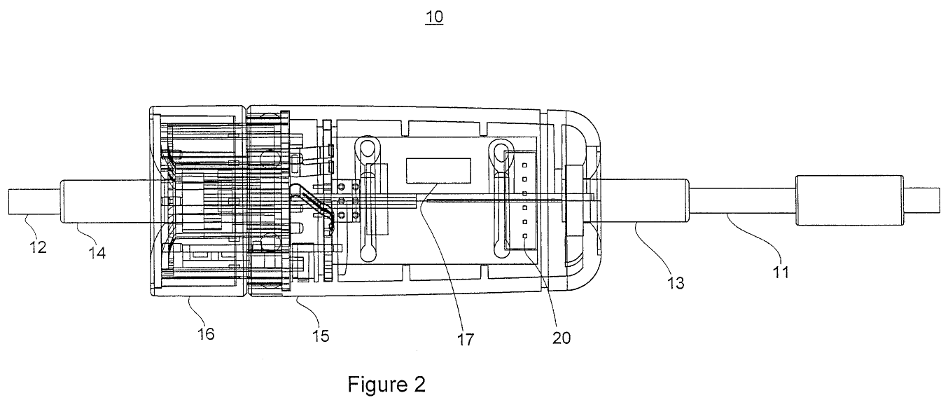

Referring now to FIG. 2, a cut-away line view of housing 10 of the exemplary embodiment is shown. Tap 20, representing the six elements shown as small squares, is a detent-type positive connection for a preset operating FM frequency. While there may be as many as twenty taps, typically between six and eight taps are sufficient. When dial 16 is rotated by the user, a wiper (not shown) moves from one tap to another. When the wiper reaches a tap, a positive stop occurs due to the detent design of each tap, providing the user with a tactile indication of the quick, positive, and accurate frequency change. The user thus does not need to look at the selector to effect a frequency change. The apparatus then transmits the data, audio or video, to the EES over a short range wireless FM frequency link.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.”

All structural and functional equivalents to the elements of the above-described preferred embodiment and additional embodiments that are known to those of ordinary skill in the art are hereby expressly incorporated by reference and are intended to be encompassed by the present claims. However, it should be readily apparent to those of ordinary skill in the art that various changes and modifications in form, apparatus material, and fabrication material detail may be made without departing from the spirit and scope of the invention as set forth in the appended claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. No claim herein is to be construed under the provisions of 35 U.S.C. 112, sixth paragraph, unless the element is expressly recited using the phrase “means for.”

### INDUSTRIAL APPLICABILITY

The present invention applies industrially to cables for connecting portable personal electronic devices to an external entertainment system for playback of audio, video or data.

What is claimed:

1. An electrical cable for connecting a portable personal electronic device to an external entertainment system, comprising:
a housing for an FM frequency receiver-transmitter device having at least two pre-set frequency taps for transferring an electrical output from the portable personal electronic device to the external entertainment system, the at least two taps having detent connections with a rotatable dial selector for selecting one of the at least two taps;
a first cable having a jack connector at one end for connection with the external entertainment system and a rotatable electrical connector at the distal end for electrical connection with the selected FM device tap within the housing; and
a second cable having a jack connector at one end for connection with the portable personal electronic device and a rotatable electrical connector at the distal end for connection with the FM device within the housing;

2. The electrical cable in accordance with claim 1 further having a number of taps selected from the group of numbers between two and twenty.

3. The electrical cable in accordance with claim 2 wherein the number of taps is a number between six and eight.

4. The electrical cable in accordance with claim 3 wherein each of the taps is pre-set to a separate FM frequency.

5. The electrical cable in accordance with claim 1 wherein the dial selector is rotatable throughout a 360 degree circle.

6. The electrical cable in accordance with claim 1 with the housing further having a display section.

7. The electrical cable in accordance with claim 6 wherein the display section is a back-lighted transparent panel.

8. The electrical cable in accordance with claim 6 wherein the display section displays one or more datum selected from the group of data consisting of lights, numbers and symbols.

9. (Reserved)

10. An electrical cable for connecting a portable personal electronic device to an external entertainment system, comprising:
a housing for an FM frequency receiver-transmitter device having at least six pre-set frequency taps for transferring an electrical output from the portable personal electronic device to the external entertainment system, the at least six taps having detent connections with a rotatable dial selector for selecting one of the at least six taps, wherein the dial selector is rotatable throughout a 360 degree circle in either a clock-wise or counterclockwise direction;
a first cable having a jack connector at one end for connection with the external entertainment system and a rotatable electrical connector at the distal end for electrical connection with the selected FM device tap within the housing; and
a second cable having a jack connector at one end for connection with the portable personal electronic device and a rotatable electrical connector at the distal end for connection with the FM device within the housing;

11. The electrical cable in accordance with claim 10 wherein the number of taps is at least eight.

12. The electrical cable in accordance with claim 11 with the housing further having a display section.

13. The electrical cable in accordance with claim 12 wherein the display section is a back-lighted transparent panel.
